(19) United States
(12) Patent Application Publication
(10) Pub. No.: US 2019/0283538 A1
(43) Pub. Date: Sep. 19, 2019

(54) ARRANGEMENT FOR HEATING A VEHICLE INTERIOR

(71) Applicant: Mahle International GmbH, Stuttgart (DE)

(72) Inventors: Oliver Schultze, Stuttgart (DE); Joachim Treier, Oppenau (DE)

(21) Appl. No.: 16/354,938

(22) Filed: Mar. 15, 2019

(30) Foreign Application Priority Data
Mar. 16, 2018 (DE) 102018204058.3

(51) Int. Cl. B60H 1/22

(52) U.S. Cl. CPC B60H 1/2225; H05B 2203/02

(57) ABSTRACT

An arrangement is provided for heating a vehicle interior of a motor vehicle. The arrangement comprises an air duct extending along a direction of extension and being defined by a duct housing, for air to flow through, which, in a cross section perpendicular to the direction of extension, comprises a first duct zone, via which the air can be introduced into a first interior zone of the vehicle interior, and a second duct zone, via which the air can be introduced into a second interior zone of the vehicle interior. The arrangement further comprises at least one heating device arranged in the air duct, comprising a plurality of heating sections, which extend at right angles to the direction of extension in the air duct (and have electrical PTC heating elements.

### CROSS-REFERENCE TO RELATED APPLICATION

This application claims priority to German Application DE 10 2018 204 058.3 filed on Mar. 16, 2018, the contents of which are hereby incorporated by reference in their entirety.

### TECHNICAL FIELD

The present invention relates to an arrangement comprising a heating device having PTC heating elements for heating a vehicle interior of a motor vehicle. The invention further relates to a motor vehicle comprising such an arrangement.

### BACKGROUND

Electrically operated PTC heating elements for heating devices have a high process safety and do not overheat. Due to these advantageous characteristics, PTC heating elements are in particular used in the automobile sector. PTC heating elements are used for the vehicle interior heating, among other things.

### SUMMARY

It is an object of the present invention to show new ways in the development of arrangements for heating vehicle interiors by means of electrical PTC heating elements. An arrangement is to in particular be created, which makes it possible in a technically simple and thus cost-efficient manner to supply a different heating power to different interior zones of a vehicle interior.

It is thus the basic idea of the invention to arrange a heating device comprising electrical PTC heating elements in two duct zones of an air duct in such a way that a number of the PTC heating elements arranged in the first duct zone differs from a number of the PTC heating elements arranged in the second duct zone. The air flowing through the first duct zone is heated more strongly or weakly than the air flowing through the second duct zone in this way. Due to the fact that the air, which is led through the two duct zones, is guided into different interior zones of a vehicle interior, a different heating power—in the form of air heated to varying degrees—can thus be supplied to said interior zones in a simple manner. In this way, this higher heating power can be provided to those interior zones of a motor vehicle, which require a higher heating power than other interior zones for the temperature control, in a simple manner.

An arrangement according to the invention for heating a vehicle interior of a motor vehicle comprises an air duct extending along a direction of extension and being defined by a duct housing, for air to flow through. In a cross section perpendicular to the direction of extension, the air duct has a first duct zone, via which the air is introduced into a first interior zone of the vehicle interior. In the cross section, the air duct likewise has at least a second duct zone, via which the air is introduced into a second interior zone of the vehicle interior. The arrangement further has at least one heating device, which is arranged in the air duct. This heating device comprises a plurality of heating sections, which extend at right angles to the direction of extension in the air duct and which, in turn, have electrical PTC heating elements. According to the invention, each heating section is divided at least into a first section portion, which is arranged in the first duct zone, and into a second section portion, which is arranged in the second duct zone. According to the invention, the number of all electrical PTC heating elements arranged in the first section portions differs from the number of all electrical PTC heating elements arranged in the second section portions.

According to a preferred embodiment, a different number of electrical PTC heating elements is provided in at least one heating section, preferably in at least two heating sections, highly preferably in every heating section, in the first section portion thereof than in the second section portion thereof.

In the case of a further preferred embodiment, no electrical PTC heating element is arranged in at least one heating section, preferably in at least two heating sections, in the first or in the second section portion. This embodiment represents a simple option for realizing the different number of heating elements, which is essential for the invention, in the first and second duct zone.

Particularly advantageously, the heating sections comprising the electrical PTC heating elements are arranged in a plane perpendicular to the direction of extension. It is ensured in this way that the electrical PTC heating elements are flown through perpendicular to the main flow direction of the air in the air duct.

Particularly preferably, a cross sectional surface formed by the first duct zone is of the same size as a cross sectional surface formed by the second duct zone in the cross section perpendicular to the direction of extension.

According to an advantageous further development, a virtual axis of symmetry, which halves the duct section of the air duct into two duct halves arranged axially symmetrically to one another, which form the first and second duct zone, runs in the cross section perpendicular to the direction of extension.

Advantageously, the heating sections extend along a joint longitudinal direction and are arranged at a distance from one another with regard to a transverse direction running at right angles to the longitudinal direction. In this way, the air can pass through the spaces, which are formed between two adjacent heating sections without only minimal pressure drop.

Particularly preferably, the PTC heating elements are embodied as identical parts. This embodiment is associated with particularly low production costs. Due to the fact that identical parts are used, the desired different heating powers in the two duct zones can thus be realized in a simple manner by specifying the number of PTC heating elements, which are arranged in the two duct zones.

In the case of a further preferred embodiment, all PTC heating elements are connected to an electrical power supply during operation of the at least one heating device, so that a first electrical total heating power is provided by means of the totality of all electrical PTC heating elements, which are arranged in the first duct zone. This first electrical total heating power differs from a second electrical total heating power, which is provided by all PTC heating elements, which are arranged in the second duct zone.

According to another preferred embodiment, at least one heating section of the heating device is electrically connected to the electrical power supply by means of a semiconductor switch. If necessary, in particular when a reduction of the generated heating power is desired, the respective heating section can be electrically separated from the power supply in this way and can be deactivated in this way.

According to another advantageous further development, two heating devices are arranged next to one another in the air duct, so that the first and second section portions of the two heating devices are assigned to a total of four different duct zones. This makes it possible to individually heat four different interior zones in the vehicle interior and to supply them with an individual, in particular different, heating power. In additional further developments, it is possible, on principle, to arrange a different number of heating devices, in particular three or more heating devices, next to one another, so as to individually heat a generally arbitrary number of different interior zones in this way or to supply them with an individual heating power, respectively.

The invention further relates to a motor vehicle comprising a vehicle interior, which has a first and a second interior zone. The motor vehicle furthermore comprises an arrangement introduced above comprising an air duct and comprising at least one heating device. The above-described advantages of the arrangement according to the invention thus also transfer to the motor vehicle according to the invention. The air duct of the arrangement and the vehicle interior of the motor vehicle are thereby adapted to one another in such a way that the air, which flows through the first duct zone, essentially reaches into the first interior zone, and the air, which flows through the second duct zone, essentially reaches into the second interior zone.

According to a preferred embodiment, the first interior zone comprises a sitting area for a driver of the motor vehicle in the vehicle interior. The second interior zone in the vehicle interior analogously comprises a sitting area for a passenger of the motor vehicle.

Further important features and advantages of the invention follow from the subclaims, from the drawing, and from the corresponding figure description by means of the drawing.

Preferred exemplary embodiments of the invention are illustrated in the drawing and will be described in more detail in the following description.

It goes without saying that the above-mentioned features and the features, which will be described below, cannot only be used in the respectively specified combination, but also in other combinations or alone, without leaving the scope of the present invention.

### BRIEF DESCRIPTION OF THE DRAWINGS

In each case schematically:

FIG. 1 shows a first exemplary embodiment of an arrangement according to the invention.

FIG. 2 shows a further development of the example of FIG. 1.

### DETAILED DESCRIPTION

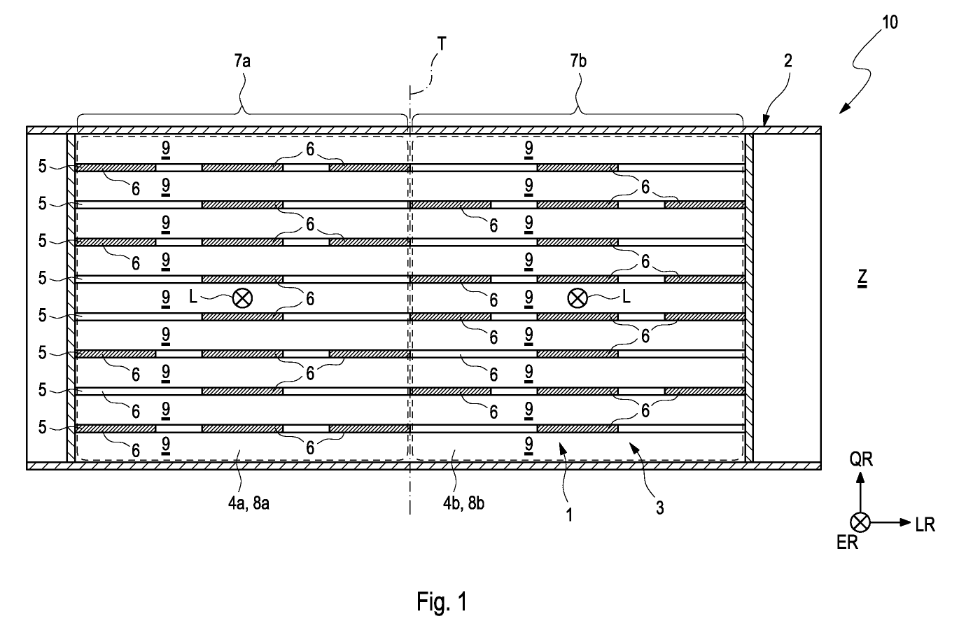

FIG. 1 shows, in a highly simplified illustration, an example of an arrangement 10 according to the invention for heating a vehicle interior (not shown) of a motor vehicle. The arrangement 10 comprises an air duct 3, which extends along a direction of extension ER and is defined by a duct housing 2, for air L to flow through. FIG. 1 shows the air duct 3 in a cross section perpendicular to the direction of extension ER. In the cross section, the air duct 3 is thus divided into a first duct zone 4a, via which the air L can be introduced into a first interior zone the vehicle interior, and into a second duct zone 4b, via which the air L can be introduced into a second interior zone of the vehicle interior.

In other words, air L, which passes through the first duct zone 4a along the direction of extension ER, is subsequently guided into the first interior zone of the vehicle interior by means of suitable embodiment of the air duct 3. Air L, which passes through the second duct zone 4b along the direction of extension ER, is accordingly guided into the second interior zone by means of suitable embodiment of the air duct 3. For this purpose, it is conceivable to provide a branch on the air duct 3 at a suitable location, from which branch a first partial duct leads into the first interior zone and a second partial duct leads into the second interior zone (not shown). It is conceivable, for example, that the first interior zone comprises a sitting area for a driver of the motor vehicle in the vehicle interior. The second interior zone can accordingly comprise a sitting area for a passenger of the motor vehicle in the vehicle interior.

The air L is heated by means of a heating device 1 of the arrangement 10, before it is introduced into the vehicle interior, whereby the vehicle interior is heated. For this purpose, the heating device 1 is arranged in the air duct 3 and comprises a plurality of heating sections 5, which extend at right angles as well as perpendicular to the direction of extension ER in the air duct 3. Each heating section 5 thereby has at least one electrical PTC heating element 6 for heating the air L in response to passing through the heating sections 5. Each heating section 5 is further divided into a first section portion 7a, which is arranged in the first duct zone 4a, and into a second section portion 7b, which is arranged in the second duct zone vb. The above-mentioned branch can thereby in particular be provided in a portion of the air duct 3, in which the heating sections 5 comprising the PTC heating elements 6 are arranged. The heating sections 5 of the heating device 1 comprising the PTC heating elements 6 are arranged in a plane Z perpendicular to the direction of extension ER. The heating sections 5 extend along a joint longitudinal direction LR and are arranged at a distance from one another with regard to a transverse direction QR running at right angles to the longitudinal direction. The air L, which flows through the air duct 3, can thus flow through the spaces 9 formed in each case between two adjacent heating sections 5.

A virtual axis of symmetry T in the form of a straight dividing line, which halves the duct section of the air duct 3 into two duct halves 8a, 8b, which, in turn, form the first or second duct zone 4a, 4b, respectively, can be seen in the cross section shown in FIG. 1 perpendicular to the direction of extension ER. As is clearly shown in FIG. 1, a cross sectional surface of the first duct zone 4a or of the first duct half 8a, respectively, is of the same size as a cross sectional surface of the second duct zone 4b or of the second duct half 8b, respectively, in the cross section perpendicular to the direction of extension ER.

As can be seen in FIG. 1, a number n1 of all electrical PTC heating elements 6, which are arranged in the first section portions 7a, differs from a number n2 of all electrical PTC heating elements 6, which are arranged in the second section portions.

As can further be seen in FIG. 1, a different number of electrical PTC heating elements 6 can be arranged in the first section portions 7a of a respective heating section 5 than in the second section portion 7b thereof. In the example scenario of FIG. 1, three PTC heating elements 6 are arranged in the first section portion 7a of a respective heating section 5, whereas only a single PTC heating element 6 is arranged in the second section portion 7b of the same heating section 5, or vice versa. It is also conceivable to forgo the provision of an electrical PTC heating element 6 in one or in a plurality of heating sections 5 in the first or in the second section portion 7a, 7b.

Advantageously, the electrical PTC heating elements 6 are embodied as identical parts. This means that all PTC heating elements 6 generate the same heating power, when they obtain the same electrical power from an electrical power supply. During operation of the heating device 1, all electrical PTC heating elements 6 are connected to such an electrical power supply, which is not illustrated in detail in FIG. 1. The electrical wiring of the PTC heating elements 6 to the electrical power supply is thereby realized in such a way that all PTC heating elements 6 obtain the same electrical heating power from the electrical power supply during operation of the heating device 1. Due to the fact that the PTC heating elements 6 are embodied as identical parts and a different number of PTC heating elements 6 is arranged in the first duct zone 4a than in the second duct zone 4b, the totality of all electrical PTC heating elements 6, which are arranged in the first duct zone, generate a first electrical total heating power P1, which differs from a second electrical total heating power P2, which is generated by all PTC heating elements 6, which are arranged in the second duct zone 4b.

The individual heating sections 5 can in each case be electrically connected to the electrical power supply by means of a semiconductor switch (not shown), for example in the form of a power transistor, so that they can be electrically separated from the power supply.

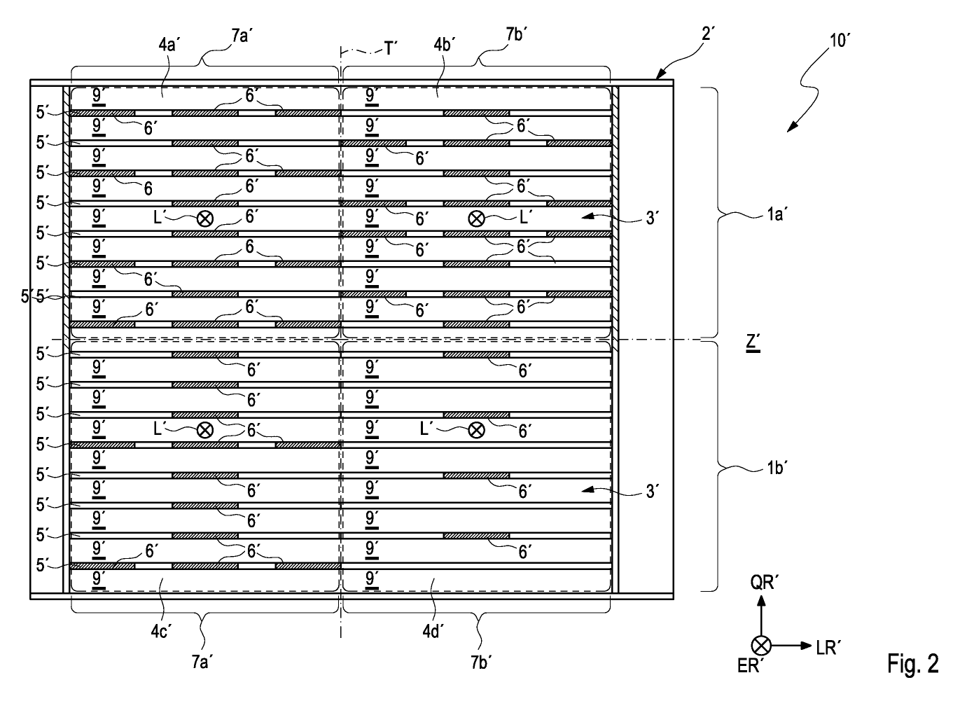

FIG. 2 shows a further development of the arrangement 10 of FIG. 1. In the case of the arrangement 10′, two heating devices 1a′, 1b′ are arranged next to one another along the transverse direction QR′ in the air duct 3′, so that the heating sections 5′ of the two heating devices are assigned to a total of four different duct zones 4a′, 4b′, 4c′, 4d′. The two additional duct sections 4c′, 4d′ as compared to FIG. 1 can be assigned to a third as well as fourth interior zone of the vehicle interior. It is conceivable, for example, that the third interior zone comprises a sitting area for a passenger in the left rear area of the motor vehicle in the vehicle interior. The fourth interior zone can likewise comprise a sitting area for a passenger in the right rear area of the motor vehicle in the vehicle interior.

1. An arrangement for heating a vehicle interior of a motor vehicle, comprising:
an air duct extending along a direction of extension and being defined by a duct housing, for air to flow through, which, in a cross section perpendicular to the direction of extension, comprises a first duct zone, via which the air can be introduced into a first interior zone of the vehicle interior, and a second duct zone, via which the air can be introduced into a second interior zone of the vehicle interior,
at least one heating device arranged in the air duct, comprising a plurality of heating sections, which extend at right angles to the direction of extension in the air duct and have electrical PTC heating elements, wherein each heating section is divided at least into a first section portion, which is arranged in the first duct zone, and into a second section portion, which is arranged in the second duct zone,
wherein a first quantity of the electrical PTC heating elements arranged in the first section portions differs from a second quantity of the electrical PTC heating elements that are arranged in the second section portions.

2. The arrangement according to claim 1, wherein a different number of electrical PTC heating elements is provided in at least one heating section, in at least two heating sections, in every heating section, in the first section portion thereof than in the second section portion thereof.

3. The arrangement according to claim 1, wherein no electrical PTC heating element is arranged in at least one heating section, in at least two heating sections, in the first or in the second section portion.

4. The arrangement according to one claim 1, the heating sections comprising the PTC heating elements are arranged in a plane perpendicular to the direction of extension.

5. The arrangement according to claim 1, wherein a cross sectional surface of the first duct zone is of the same size as a cross sectional surface of the second duct zone in the cross section perpendicular to the direction of extension.

6. The arrangement according to claim 1, wherein a virtual axis of symmetry, which halves the duct section of the air duct into two duct halves arranged axially symmetrically to one another, which form the first and second duct zone, is present in the cross section perpendicular to the direction of extension.

7. The arrangement according to claim 1, wherein the heating sections extend along a joint longitudinal direction and are arranged at a distance from one another with regard to a transverse direction running at right angles to the longitudinal direction, so that the air can pass through the spaces, which are formed between two adjacent heating sections.

8. The arrangement according to claim 1, wherein the PTC heating elements are embodied as identical parts.

9. The arrangement according to claim 1, wherein the PTC heating elements are connected to an electrical power supply during operation of the heating device, so that a first electrical total heating power is provided by the totality of all electrical PTC heating elements, which are arranged in the first duct zone, which first electrical total heating power differs from a second electrical total heating power, which is provided by all PTC heating elements, which are arranged in the second duct zone.

10. The arrangement according to claim 9, wherein at least one heating section is electrically connected to the electrical power supply by a semiconductor switch, so that said heating section can be electrically separated from the power supply.

11. An arrangement comprising:
an air duct extending along a direction of extension and being defined by a duct housing, the air duct including a first duct zone to introduce air into a first interior zone of the vehicle interior, and a second duct zone to introduce air into a second interior zone of the vehicle interior, and
two heating devices arranged in the air duct and including a plurality of heating sections with electrical heating elements, each of the two heating devices being divided into a first section portion arranged in the first duct zone and a second section portion arranged in the second duct zone,
wherein a first quantity of the electrical heating elements arranged in the first section portion differs from a second quantity of electrical heating elements are arranged in the second section portion, and
wherein the two heating devices are arranged next to one another in the air duct, so that the first and second section portions of the two heating devices are assigned to a total of four different duct zones.

12. A motor vehicle including a vehicle interior with a first interior zone and a second interior zone, comprising:
an air duct extending along a direction of extension and being defined by a duct housing, the air duct including a first duct zone to introduce air into a first interior zone of the vehicle interior, and a second duct zone to introduce air into a second interior zone of the vehicle interior, and
a heating device arranged in the air duct and including a plurality of heating sections with electrical heating elements divided into a first section portion arranged in the first duct zone and a second section portion arranged in the second duct zone,
wherein the air duct and the vehicle interior are adapted to one another in such a way that the air that flows through the first duct zone reaches into the first interior zone, and the air that flows through the second duct zone reaches into the second interior zone.

13. The motor vehicle according to claim 12, wherein the first interior zone comprises a sitting area for a driver of the motor vehicle in the vehicle interior, and the second interior zone comprises a sitting area for a passenger of the motor vehicle in the vehicle interior.

14. A system for a vehicle interior of a motor vehicle, comprising:
an air duct extending along a direction of extension and being defined by a duct housing, the air duct including a first duct zone to introduce air into a first interior zone of the vehicle interior, and a second duct zone to introduce air into a second interior zone of the vehicle interior; and
at least one heating device arranged in the air duct and including a plurality of heating sections including electrical PTC heating elements divided at least into a first section portion arranged in the first duct zone and a second section portion arranged in the second duct zone.

15. The system according to claim 14, wherein the PTC heating elements are arranged in a plane perpendicular to the direction of extension.

16. The system according to claim 14, wherein a cross sectional surface of the first duct zone is of the same size as a cross sectional surface of the second duct zone in the cross section perpendicular to the direction of extension.

17. The system according to claim 14, wherein a virtual axis of symmetry, which halves the duct section of the air duct into two duct halves arranged axially symmetrically to one another, which form the first and second duct zone, is present in the cross section perpendicular to the direction of extension.

18. The system according to claim 14, wherein the heating sections extend along a joint longitudinal direction and are arranged at a distance from one another with regard to a transverse direction running at right angles to the longitudinal direction, so that the air can pass through the spaces formed between two adjacent heating sections.

19. The system according to claim 14, wherein the PTC heating elements are connected to an electrical power supply during operation of the heating device, so that a first electrical total heating power is provided by the electrical PTC heating elements arranged in the first duct zone, wherein the first electrical total heating power differs from a second electrical total heating power provided by the PTC heating elements arranged in the second duct zone.

20. The system according to claim 19, wherein at least one heating section is electrically connected to the electrical power supply by a semiconductor switch, so that said heating section can be electrically separated from the power supply.
